(19) United States
(12) Patent Application Publication
(10) Pub. No.: US 2022/0398361 A1
(43) Pub. Date: Dec. 15, 2022

(54) METHOD AND APPARATUS FOR MODELING PHOTOVOLTAIC POWER CURVE, AND COMPUTER DEVICE AND STORAGE MEDIUM THEREOF

(71) Applicants: ENVISION DIGITAL INTERNATIONAL PTE. LTD., Singapore (SG); SHANGHAI ENVISION DIGITAL CO., LTD., Shanghai (CN)

(72) Inventors: Renyu YUAN, Shanghai (CN); Zibo DONG, Singapore (SG); Ying YAO, Shanghai (CN); Yangyang ZHAO, Shanghai (CN); Hui YANG, Shanghai (CN); Qingsheng ZHAO, Shanghai (CN)

(73) Assignees: ENVISION DIGITAL INTERNATIONAL PTE. LTD., Singapore (SG); SHANGHAI ENVISION DIGITAL CO., LTD., Shanghai (CN)

(21) Appl. No.: 17/777,025

(22) PCT Filed: Nov. 13, 2020
(86) PCT No.: PCT/SG2020/050659

§ 371 Date: May 14, 2022

(30) Foreign Application Priority Data
Nov. 14, 2019 (CN) 201911112139.4

(51) Int. Cl. G06F 30/20

(52) U.S. Cl. CPC G06F 30/20; G06F 2119/06

(57) ABSTRACT

The present disclosure relates to a method and apparatus for modeling a photovoltaic power curve, and a computer device and a storage medium thereof. The method includes: acquiring photovoltaic data at various time points within a specified time period; dividing the photovoltaic data at the various time points into at least two photovoltaic data packets; and establishing, according to the respective photovoltaic data of the at least two photovoltaic data packets, packet photovoltaic power curves respectively corresponding to the at least two photovoltaic data packets. By the method, the photovoltaic data is fitted in different time periods during the photovoltaic curve modeling process, thereby reducing the influence of the difference between photoelectric conversion efficiencies in different time periods on photovoltaic curve modeling, and improving the accuracy of photovoltaic curve modeling.

### TECHNICAL FIELD

The present disclosure relates to the technical field of photovoltaic power generation, and more particularly, relates to a method and apparatus for modeling a photovoltaic power curve, and a computer device and a storage medium thereof.

### BACKGROUND

With the large-scale application of photovoltaics to power grids, time variation, volatility and randomness caused by photovoltaics may exert a huge impact on the safe and stable operation of the power grids, which greatly increases the difficulty in dispatching of the power grids. The photovoltaic power prediction technology is a basic technology to improve the quality of photovoltaic grid connection, optimize a power grid dispatching plan, and promote the safe and stable operation of the power grid, and is of great significance to ensuring the safe and stable operation of the power grid. Therefore, this technology is of great practical significance to conducting photovoltaic power prediction.

In the related art, based on real-time irradiation observation data of a photovoltaic field station and corresponding actual photovoltaic generated power data, a statistical regression method is used to establish a photoelectric conversion regression equation, thereby obtaining a relationship curve showing the conversion between the irradiance and the generated power of a photovoltaic device.

In the related art, all photovoltaic data is subjected to once fitting in the relationship curve showing the conversion between the irradiance and the generated power, resulting in a poor fitting effect and low precision.

### SUMMARY

Embodiments of the present disclosure provide a method and apparatus for modeling a photovoltaic curve modeling, and a computer device and a storage medium thereof, which can improve the accuracy in photovoltaic curve modeling. The technical solutions are as follows.

In one aspect, a method for modeling a photovoltaic curve is provided. The method includes the following steps:

acquiring photovoltaic data at various time points within a specified time period;

dividing the photovoltaic data at the various time points into at least two photovoltaic data packets, different packets in the at least two photovoltaic data packets corresponding to different time periods; and

establishing, according to the respective photovoltaic data of the at least two photovoltaic data packets, packet photovoltaic power curves respectively corresponding to the at least two photovoltaic data packets.

In one aspect, an apparatus for modeling a photovoltaic curve is provided. The apparatus includes:

an acquiring module, configured to acquire photovoltaic data at various time points within a specified time period, wherein the irradiation detection device is disposed at the photovoltaic power generation device;

a packetizing module, configured to divide the photovoltaic data at various time points into at least two photovoltaic data packets, different packets in the at least two photovoltaic data packets corresponding to different time periods; and

an establishing module, configured to establish, according to the respective photovoltaic data of the at least two photovoltaic data packets, packet photovoltaic power curves respectively corresponding to the at least two photovoltaic data packets.

Optionally, the apparatus further includes: a cleaning module, configured to perform data cleaning on the respective photovoltaic data of the at least two photovoltaic data packets to remove invalid photovoltaic data in the at least two photovoltaic data packets; and

the establishing module is configured to establish, according to photovoltaic data of the at least two photovoltaic data packets subjected to the data cleaning, packet photovoltaic power curves respectively corresponding to the at least two photovoltaic data packets.

Optionally, the photovoltaic data includes a generated power of a photovoltaic power generation device at a corresponding time point, and an irradiance collected by a radiation detection device at a corresponding time point; the irradiation detection device is disposed at the photovoltaic power generation device; and

the cleaning module includes:

a first cleaning submodule, configured to clean abnormal data in the at least two photovoltaic data packets to obtain the at least two photovoltaic data packets subjected to abnormal data cleaning, wherein the abnormal data refers to data generated in the case of failure of the irradiation detection device;

a second cleaning submodule, configured to remove low-relevancy data from the at least two photovoltaic data packets subjected to the abnormal data cleaning, to obtain the at least two photovoltaic data packets subjected to low-relevancy data cleaning, wherein the low-relevancy data refers to photovoltaic data whose relevancy is lower than a relevancy threshold, and the relevancy is intended to indicate a correlation between the generated power and the irradiance in the corresponding photovoltaic data;

a third cleaning submodule, configured to remove outlier data respectively based on a local outlier factor algorithm from the at least two photovoltaic data packets subjected to the low-relevancy data cleaning, to acquire the at least two photovoltaic data packets from which the outlier data is removed, wherein the outlier data refers to photovoltaic data away from a data concentration area; and

a first acquisition submodule, configured to acquire, according to the at least two photovoltaic data packets from which the outlier data is removed, the at least two photovoltaic data packets subjected to the data cleaning.

Optionally, the first cleaning submodule is configured to:

clean missing data in the at least two photovoltaic data packets, wherein the missing data refers to data in which the irradiance data or the generated power data in the photovoltaic power data is missed;

clean nighttime invalid data in the at least two photovoltaic data packets, wherein the nighttime invalid data refers to all data obtained by the photovoltaic power detection device during the nighttime detection;

clean overrun data in the at least two photovoltaic data packets, wherein the overrun data refers to data that exceeds a reasonable irradiance data range and/or a reasonable power data range; and

clean dead numbers in the at least two photovoltaic data packets, wherein the dead numbers refer to data that appears four times or more in a time sequence.

Optionally, the second cleaning submodule is configured to:

establish sliding windows, wherein each of the sliding windows is established by the photovoltaic data in the at least two photovoltaic data packets subjected to the abnormal data cleaning in a time sequence by taking a time resolution of the photovoltaic data in the at least two photovoltaic data packets subjected to the abnormal data cleaning as a step length, and each n pieces of photovoltaic data as a set, wherein the each n pieces of photovoltaic data is considered as a set of data, and one sliding window contains the set of data; and the time resolution refers to a minimum time interval at which the irradiation detection device collects two pieces of adjacent photovoltaic data at a corresponding time point;

calculate a Pearson correlation coefficient of the photovoltaic data within each of the sliding windows;

calculate a correlation value of the photovoltaic data in the at least two photovoltaic data packets subjected to the abnormal data cleaning, wherein the correlation value refers to an average value which is solved, by sorting the Pearson correlation coefficients of a plurality of sliding windows in which the photovoltaic data in the at least two photovoltaic data packets subjected to the abnormal data cleaning is located in a descending order, for values of the middle n−2 Pearson correlation coefficients;

determine a correlation threshold, wherein the correlation threshold refers to a correlation threshold corresponding to each of the data segments divided based on irradiance data segments; and

clean the photovoltaic data in the at least two photovoltaic data packets subjected to the abnormal data cleaning according to the correlation threshold.

Optionally, the first acquisition submodule is configured to:

determine over-cleaned data from respective low-relevancy data of the at least two photovoltaic data packets based on an inter-quartile range algorithm, wherein the over-cleaned data is photovoltaic data in a data concentration area and in a preset area around the data concentration area; and

recover the respective over-cleaned data of the at least two photovoltaic data packets into the at least two photovoltaic data packets from which the outlier data is removed, to obtain the at least two photovoltaic data packets subjected to the data cleaning.

Optionally, the establishing module is configured to perform spline interpolation fitting on the respective photovoltaic data of the at least two photovoltaic data packets to obtain a photovoltaic power curve of the photovoltaic power generation device.

In one aspect, a computer device is provided. The computer device includes a processor and a memory; wherein the memory is configured to store at least one instruction, at least one program, a code set, or an instruction set therein, which, when loaded and executed by the processor, enables the processor to perform the method for modeling the photovoltaic curve.

In one aspect, a computer readable storage medium is provided. The storage medium is configured to store at least one instruction, at least one program, a code set, or an instruction set, which, when loaded and executed by a processor, enables the processor to perform the method for modeling the photovoltaic curve.

The technical solutions according to the present disclosure may achieve the following beneficial effects:

The photovoltaic power curve is obtained by dividing the acquired photovoltaic data at various time points within a specified time period into at least two photovoltaic data packets, establishing packet photovoltaic power curves respectively corresponding to the at least two photovoltaic data packets according to the respective photovoltaic data of the at least two photovoltaic data packets and fitting the respective packet photovoltaic power curves of at least two photovoltaic data packets, such that the photovoltaic data is fitted in different time periods during the photovoltaic curve modeling process, thereby reducing the influence of the difference between photoelectric conversion efficiencies in different time periods on photovoltaic curve modeling, and improving the accuracy of photovoltaic curve modeling.

It is to be understood that both the foregoing general description and the following detailed description are exemplary and explanatory only and are not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart of a method for modeling a photovoltaic curve according to an exemplary embodiment of the present disclosure;

FIG. 2 is a flowchart of a method for modeling a photovoltaic curve according to another embodiment of the present disclosure;

FIG. 3 is a schematic diagram of a sliding window in a method for modeling a photovoltaic curve involved in an embodiment of the present disclosure;

FIG. 4 is a flowchart of a method for modeling a photovoltaic curve according to a further exemplary embodiment of the present disclosure;

FIG. 5 is a scatter diagram of photovoltaic data at various time points within a specified time period in a method for modeling a photovoltaic curve according to an embodiment of the present disclosure;

FIG. 6 is a scatter diagram of photovoltaic data in the morning in a method for modeling a photovoltaic curve according to an embodiment of the present disclosure;

FIG. 7 is a scatter diagram of photovoltaic data in the afternoon in a method for modeling a photovoltaic curve according to an embodiment of the present disclosure;

FIG. 8 is a scatter diagram of abnormal data in a method for modeling a photovoltaic curve according to an embodiment of the present disclosure;

FIG. 9 is a scatter diagram of low-relevancy data in a method for modeling a photovoltaic curve according to an embodiment of the present disclosure;

FIG. 10. is a scatter diagram of outlier data in a method for modeling a photovoltaic curve according to an embodiment of the present disclosure;

FIG. 11. is a scatter diagram of over-cleaned data in a method for modeling a photovoltaic curve according to an embodiment of the present disclosure;

FIG. 12. is a photovoltaic power curve fitting diagram of a method for modeling a photovoltaic curve according to an embodiment of the present disclosure;

FIG. 13 is a block diagram of an apparatus for modeling a photovoltaic curve according to an exemplary embodiment of the present disclosure; and

FIG. 14 is a structural block diagram of a computer device according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The embodiments set forth in the following description of exemplary embodiments do not represent all embodiments consistent with the present disclosure. Instead, these embodiments are merely examples of apparatuses and methods consistent with aspects related to the disclosure as recited in the appended claims.

Understandably, the term “plurality” herein refers to two or more. “And/or” herein describes the correspondence of the corresponding objects, indicating three kinds of relationship. For example, A and/or B, can be expressed as: A exists alone, A and B exist concurrently, B exists alone. The character “/” generally indicates that the context object is an “OR” relationship.

With the large-scale access of photovoltaics to a power grid, higher requirements are proposed for a photovoltaic power prediction technology. The present disclosure provides a method for modeling a photovoltaic curve, which can improve the accuracy of photovoltaic curve modeling. For ease of understanding, several terms involved in the present disclosure are explained below.

1) Photovoltaic

Photovoltaic, also known as a photovoltaic effect, is short for a solar power system, and is a novel power generation system that converts solar radiation energy into electrical energy directly by use of a photovoltaic effect of a solar cell semiconductor material.

2) Irradiance Intensity

Irradiance intensity, referred to as irradiance, is defined as the energy passed per unit area.

3) Photoelectric Conversion Efficiency

Photoelectric conversion efficiency, also known as monochromatic incident photon-to-electron conversion efficiency (IPCE), is defined as a ratio of the number of electrons generated in an external circuit per unit time to the number of incident monochromatic photons per unit time.

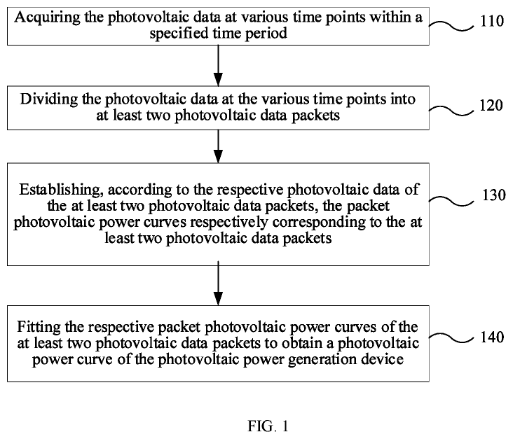

FIG. 1 shows a flowchart of a method for modeling a photovoltaic curve according to an exemplary embodiment of the present disclosure. The method for modeling the photovoltaic curve is performed by a computer device. As shown in FIG. 1, the method may include the following steps.

In step 110, photovoltaic data at various time points within a specified time period is acquired. The photovoltaic data includes a generated power of a photovoltaic power generation device at a corresponding time point, and an irradiance collected by a radiation detection device at a corresponding time point. The irradiation detection device is disposed at the photovoltaic power generation device.

The photovoltaic power generation device refers to a power generation device that can convert solar energy into electrical energy directly using a solar cell. The generated power of the photovoltaic power generation device is mainly affected by the irradiance intensity of sunlight that can be received by the photovoltaic power generation device. The irradiation intensity, also known as irradiance, refers to the energy passed by the photovoltaic power generation device per unit area.

The photovoltaic power is in one-to-one correspondence to the irradiance. Each time a value of generated power is detected, an irradiance value threshold corresponding thereto is defined. In addition, the irradiance value detected by the irradiation detection device should be an irradiance value that can be received by the photovoltaic power generation device.

In step 120, the photovoltaic data at various time points is divided into at least two photovoltaic data packets. The time point corresponding to the photovoltaic data in each of the at least two photovoltaic data packets belongs to a time period with a natural day, and different packets of the at least two photovoltaic data packets correspond to different time periods.

For example, the photovoltaic data within a specified time period may be divided into two photovoltaic data packets in the morning and in the afternoon according to time points in a natural day, or may be divided into three photovoltaic data packets in the morning, in the noon and in the afternoon, or the like. A natural day means twenty-four hours a day.

It should be noted that the photovoltaic data packets proposed in the present disclosure are merely exemplary, and the photovoltaic data packeting mode, or the number of packets is not limited in the present disclosure. In the embodiment of the present disclosure, the present disclosure will be described by taking a case that the photovoltaic data in a natural day is divided into two photovoltaic data packets in the morning and in the afternoon according to the time points.

In step 130, packet photovoltaic power curves respectively corresponding to the at least two photovoltaic data packets are established according to the respective photovoltaic data of the at least two photovoltaic data packets, wherein the packet photovoltaic power curve is intended to indicate a function relationship between the irradiance and the generated power.

In the embodiment of the present disclosure, the photovoltaic curve power is established respectively for the respective photovoltaic data of the at least two photovoltaic data packets. For example, in the case that the photovoltaic data in a natural day is divided into two photovoltaic data packets in the morning and in the afternoon according to the time points, photovoltaic curve power is established for the photovoltaic data in the morning, and the photovoltaic power is established for the photovoltaic data in the afternoon, thereby obtaining two photovoltaic power curves corresponding to the photovoltaic data in the morning and the photovoltaic data in the afternoon, respectively.

In the case that the photovoltaic data in a natural day is divided into two photovoltaic data packets in the morning and in the afternoon according to the time points, the two photovoltaic power curves corresponding to the photovoltaic data in the morning and the photovoltaic data in the afternoon are fitted, to finally obtain a photovoltaic power curve with the irradiance as an X-axis and the generated power as a Y-axis.

Optionally, the obtained photovoltaic power curve of the photovoltaic device is verified, to obtain the verified photovoltaic power curve. The verified photovoltaic power curve is a photovoltaic power curve of the photovoltaic power generation device.

If the obtained photovoltaic power curve of the photovoltaic device is monotonous and satisfies reasonable photoelectric conversion efficiency, the verified photovoltaic power curve is the photovoltaic power curve of the photovoltaic device, that is, the photovoltaic power curve obtained by fitting the photovoltaic data is the photovoltaic power curve of the photovoltaic device.

If the obtained photovoltaic power curve of the photovoltaic device is monotonous and/or does not satisfy the photoelectric conversion efficiency, the verified photovoltaic power curve is a theoretical photovoltaic power curve, and the theoretical photovoltaic power curve is obtained as the photovoltaic power curve of the photovoltaic power generation device.

The photoelectric conversion efficiency in the photovoltaic industry refers to a ratio of the number of charge carriers of a solar cell to the number of photons that are irradiated at a certain energy on the surface of the solar cell.

Optionally, the theoretical photovoltaic power curve refers to a photovoltaic power curve obtained by fitting a quadratic polynomial of three points of (0, 0), (500, Cap*(1+k)/2), (1000, Cap), wherein Cap is a rated capacity of the photovoltaic device, and k is an empirical coefficient which is determined by sunshine conditions in different regions.

In summary, by the method for modeling the photovoltaic curve according to the embodiment of the present disclosure, the photovoltaic power curve is obtained by dividing the acquired photovoltaic data at various time points within a specified time period into at least two photovoltaic data packets, establishing packet photovoltaic power curves respectively corresponding to the at least two photovoltaic data packets according to the respective photovoltaic data of the at least two photovoltaic data packets and fitting the respective packet photovoltaic power curves of at least two photovoltaic data packets, such that the photovoltaic data is fitted in different time periods during the photovoltaic curve modeling process, thereby reducing the influence of the difference between photoelectric conversion efficiencies in different time periods on photovoltaic curve modeling, and improving the accuracy of photovoltaic curve modeling.

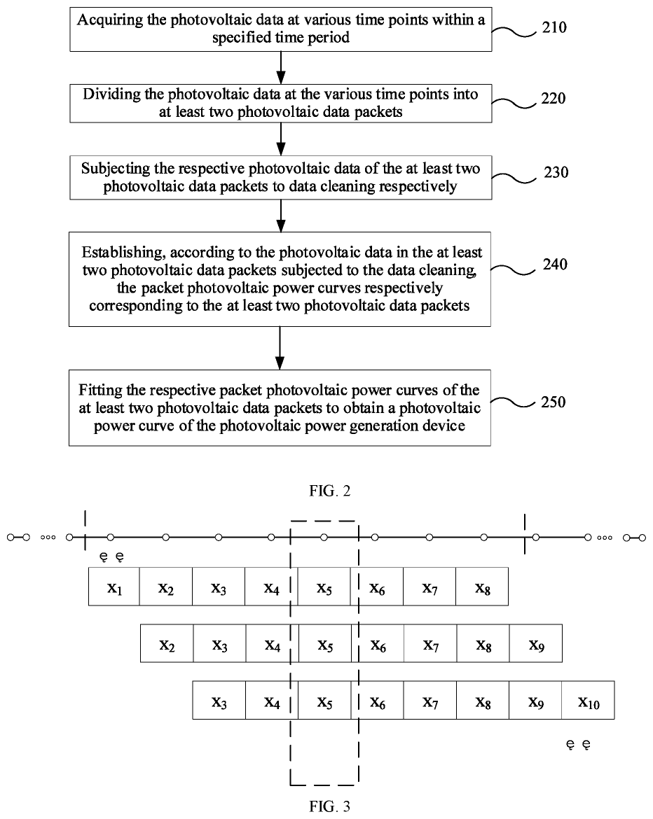

FIG. 2 shows a flowchart of a method for modeling a photovoltaic curve according to an exemplary embodiment of the present disclosure. The method for modeling the photovoltaic curve is performed by a computer device. As shown in FIG. 2, the method may include the following steps.

In step 210, photovoltaic data at various time points within a specified time period is acquired. The photovoltaic data includes a generated power of a photovoltaic power generation device at a corresponding time point, and an irradiance collected by a radiation detection device at a corresponding time point. The irradiation detection device is disposed at the photovoltaic power generation device.

In step 220, the photovoltaic data at various time points is divided into at least two photovoltaic data packets. The time point corresponding to the photovoltaic data in each of the at least two photovoltaic data packets belongs to a time period in a natural day, and different packets of the at least two photovoltaic data packets correspond to different time periods.

For details about the steps 210 and 220, reference may be made to the steps 110 and 120, which are not described in this embodiment any further.

In step 230, the respective photovoltaic data of the at least two photovoltaic data packets are subjected to data cleaning respectively, to remove invalid photovoltaic data in the at least two photovoltaic data packets.

Optionally, the invalid photovoltaic data may be generated when the irradiation detection device fails to work normally because of machine failure, natural disasters and other force majeure, limited period of photovoltaic power generation, and the like.

Optionally, performing the data cleaning on the respective photovoltaic data of the at least two photovoltaic data packets includes S2301 to S2304.

In S2301, abnormal data in the at least two photovoltaic data packets is cleaned to obtain the at least two photovoltaic data packets subjected to abnormal data cleaning, wherein the abnormal data refers to data generated in the case of failure of the irradiation detection device.

Optionally, cleaning the abnormal data in the at least two photovoltaic data packets may include:

cleaning missing data in the at least two photovoltaic data packets, wherein the missing data refers to data in which the irradiance data or the generated power data in the photovoltaic power data is missed;

cleaning nighttime invalid data in the at least two photovoltaic data packets, wherein the nighttime invalid data refers to all data obtained by the photovoltaic power detection device during the nighttime detection;

cleaning overrun data in the at least two photovoltaic data packets, wherein the overrun data refers to data that exceeds a reasonable irradiance data range and/or a reasonable power data range; and

cleaning dead numbers in the at least two photovoltaic data packets, wherein the dead numbers refer to data that appears four times or more in a time sequence.

Optionally, the reasonable irradiance range is 0-1200 W/m2, and the reasonable power data range is 0-1.1*Cap, wherein Cap is a rated capacity of the photovoltaic power generation device. In a possible case, the photovoltaic data detected by the irradiation detection device only includes irradiance data, but the generated power data corresponding thereto is not detected; or the photovoltaic data detected by the irradiation detection device only includes generated power data, but the irradiance data corresponding thereto is not detected. These data are then determined as missing data and are cleaned.

As the sun's direct point continues to do a regression movement in the North-South tropics, a change in the length of day and night in a natural day will occur. The photovoltaic power generation device is a device that converts solar energy into electrical energy. In the absence of the sun, the photovoltaic power generation device is not working, and the nighttime data detected by the irradiation detection device is invalid data. The nighttime invalid data is cleaned according to the difference in day and night of each natural day.

The irradiance intensity of sunlight and the ability of the photovoltaic power generation device to convert solar energy into electrical energy are limited. When the irradiance data detected by the irradiation detection device exceeds an irradiance intensity threshold of sunlight, or the generated power data exceeds a generated power threshold of the photovoltaic power generation device, these data are determined as invalid data, and the overrun data is cleaned.

In a possible case, due to the abnormal operation of the irradiation detection device, if a certain piece of irradiance data or generated power data detected by the irradiation detection device continuously appears four times or more in a time sequence, the data which is repeated four times or more is determined as dead numbers, and the dead numbers are then cleaned.

In S2302, low-relevancy data is removed from the at least two photovoltaic data packets subjected to the abnormal data cleaning, to obtain the at least two photovoltaic data packets subjected to low-relevancy data cleaning, wherein the low-relevancy data refers to photovoltaic data whose relevancy is lower than a relevancy threshold, and the relevancy is used to indicate a correlation between the generated power and the irradiance intensity in the corresponding photovoltaic data.

Optionally, the low-relevancy data is removed in intervals. The number of photovoltaic data intervals divided by this process may be greater than or equal to the number of photovoltaic data packets. The relevancy threshold based on which the low-relevancy data is removed can be adjusted accordingly according to different intervals.

Optionally, removing the low-relevancy data from the at least two photovoltaic data packets subjected to the abnormal data cleaning, to obtain the at least two photovoltaic data packets subjected to the low-relevancy data cleaning includes:

establishing sliding windows, wherein each of the sliding windows is established by the photovoltaic data in the at least two photovoltaic data packets subjected to the abnormal data cleaning in a time sequence by taking a time resolution of the photovoltaic data in the at least two photovoltaic data packets subjected to the abnormal data cleaning as a step length, and each n pieces of photovoltaic data as a set, wherein the each n pieces of photovoltaic data is considered as a set of data, and one sliding window contains the set of data; and the time resolution refers to a minimum time interval at which the irradiation detection device collects two pieces of adjacent photovoltaic data at a corresponding time point.

For example, FIG. 3 shows a schematic diagram of sliding windows in a method for modeling a photovoltaic curve according to an embodiment of the present disclosure. As shown in FIG. 3, 20 pieces of photovoltaic data are acquired. In the case of establishing the sliding windows, the 20 pieces of photovoltaic data are sorted in order of collection time from morning to night. It is assumed that the 20 pieces of photovoltaic data have a time resolution of 10 minutes, that is, one piece of photovoltaic data is acquired in every 10 minutes, the sliding window is established with 10 minutes as a step length. Taking 8 pieces of data as a set as an example, in the case that the 1^{st} to 8^{th} photovoltaic data is considered as a first set, 2^{nd} to 9^{th} pieces of photovoltaic data are considered as a second set, 3^{rd} to 10^{th} pieces of photovoltaic as a third set, and so on, each piece of photovoltaic data may appear in 8 packets, each of the sliding windows contains a set of photovoltaic data, and each piece of photovoltaic data will then appear in 8 sliding windows.

A Pearson correlation coefficient of the photovoltaic data within each of the sliding windows is calculated.

The Pearson correlation coefficient is used to measure whether two data sets are located on a line, and also used to measure a linear relationship between interval variables, and is calculated according to the following formula:

$$r = \frac{N \sum {x}_{i} {y}_{i} - \sum {x}_{i} \sum {y}_{i}}{\sqrt{N \sum {x}_{i}^{2} - {( \sum {x}_{i} )}^{2}} \sqrt{N \sum {y}_{i}^{2} - {( \sum {y}_{i} )}^{2}}}$$

In the above formula, r is a Pearson correlation coefficient, N is the number of photovoltaic data within each of the sliding windows, xᵢ is a horizontal coordinate, and yᵢ is a vertical coordinate.

The Pearson correlation coefficient of the photovoltaic data within each of the sliding windows is calculated according to the above relation formula.

A correlation value of the photovoltaic data in the at least two photovoltaic data packets subjected to the abnormal data cleaning is calculated, wherein the correlation value refers to an average value which is solved, by sorting the Pearson correlation coefficients of a plurality of sliding windows in which the photovoltaic data in the at least two photovoltaic data packets subjected to the abnormal data cleaning is located in a descending order, for the values of the middle n−2 Pearson correlation coefficient.

Still taking the above 20 pieces of photovoltaic data as an example, each piece of photovoltaic data appears in 8 sliding windows, then 8 Pearson correlation coefficients will be calculated. The 8 Pearson correlation coefficients are sorted in a descending order, the maximum and minimum values in the 8 Pearson correlation coefficients are removed, and the remaining middle 6 Pearson correlation coefficients are averaged to obtain an average value which is then considered as a correlation value of a piece of photovoltaic data that appears in 8 sliding windows at the same time.

A correlation threshold is determined, wherein the correlation threshold refers to a correlation threshold corresponding to each of data segments divided based on irradiance data segments.

Optionally, the correlation threshold may be adjusted by changing related parameters of the computer device. For example, the correlation threshold may be adjusted to a correlation value which can include 60%, 70% or the like of the correlation value of the data points in each data set, based on irradiance data segments. The above description is merely illustrative, and the range of the correlation threshold is not limited in the present disclosure.

After the correlation value is calculated, the photovoltaic data points of the at least two photovoltaic data packets subjected to the abnormal data cleaning may be cleaned according to the correlation threshold.

For example, the photovoltaic data in at least two photovoltaic data packets above the correlation threshold may be reserved, and the photovoltaic data in at least two photovoltaic data packets below the correlation threshold may be cleaned.

In S2303, outlier data is removed respectively based on a local outlier factor algorithm from the at least two photovoltaic data packets subjected to the low-relevancy data cleaning, to acquire the at least two photovoltaic data packets from which the outlier data is removed, wherein the outlier data refers to photovoltaic data away from a data concentration area.

The local outlier factor (LOF) algorithm is a measure of the degree of abnormality of a sample by calculating the “local reachable density”. If a ratio of the average density of sample points around a sample point to the density of this sample point is greater than 1, the less the density of this sample point than the density of samples around this sample point, and the more likely this point is an abnormal point.

In the embodiment of the present disclosure, the LOF algorithm may be used to determine the outlier data in the at least two PV data packets subjected to the low-relevancy data cleaning in different segments, and clean the outlier data.

In S2304, the at least two photovoltaic data packets subjected to the data cleaning are acquired according to the at least two photovoltaic data packets from which the outlier data is removed.

Optionally, the data in the at least two photovoltaic data packets from which the outlier data is removed is acquired as valid photovoltaic data in the photovoltaic data at various time points within a specified time period. A photovoltaic power curve is established for packets of the valid photovoltaic data respectively in segments.

Alternatively, packetizing the at least two photovoltaic data packets from which the outlier data is removed, to obtain the at least two photovoltaic data packets subjected to the data cleaning includes:

determining over-cleaned data from respective low-relevancy data of the at least two photovoltaic data packets based on an inter-quartile range algorithm, wherein the over-cleaned data is photovoltaic data in a data concentration area and in a preset area around the data concentration area; and

recovering the respective over-cleaned data of the at least two photovoltaic data packets into the at least two photovoltaic data packets from which the outlier data is removed, to obtain the at least two photovoltaic data packets subjected to the data cleaning.

The inter-quartile range (IQR) algorithm is intended to arrange various variable values in order of magnitude, then divide the sequence into four equal parts, and calculate a difference between a value of the third quartile and a value of the first quartile.

In the embodiment of the present disclosure, the IQR algorithm may be used to calculate data in at least two photovoltaic data packets in different intervals. The number of photovoltaic data intervals divided by this process may be greater than or equal to the number of photovoltaic data packets. The relevancy threshold based on which the over-cleaned data is determined may be adjusted according to different intervals.

In step 240, packet photovoltaic power curves respectively corresponding to the at least two photovoltaic data packets are established according to the photovoltaic data in the at least two photovoltaic data packets subjected to the data cleaning.

Optionally, packet photovoltaic power curves respectively corresponding to the at least two photovoltaic data packets may be established according to the photovoltaic data in the at least two photovoltaic data packets from which outlier points are removed.

Alternatively, packet photovoltaic power curves respectively corresponding to the at least two photovoltaic data packets are established according to the photovoltaic data in the at least two photovoltaic data packets from which over-cleaned points are removed.

In step 250, the respective packet photovoltaic power curves of the at least two photovoltaic data packets are fitted to obtain a photovoltaic power curve of the photovoltaic power generation device.

Optionally, the respective packet photovoltaic power curves of the at least two photovoltaic data packets are subjected to spline regression fitting to obtain a photovoltaic power curve of the photovoltaic power generation device.

The spline interpolation method is a mathematical method for making a smooth curve through a series of points with variable splines. An interpolation spline is made up of polynomials, each of which is determined by two adjacent data points.

By using the spline interpolation method, the respective packet photovoltaic power curves of at least two photovoltaic data packets may be subjected to segmented regression, thereby obtaining a photovoltaic power curve of the photovoltaic power generation device in a full irradiation section. The spline interpolation regression steps are as follows:

1) based on irradiation, segmenting photovoltaic data points in an equally spaced manner (s intervals, s+1 segment points);

2) based on the photovoltaic data points in each interval, performing polynomial fitting on each interval for n times to establish a segmented fitting equation;

3) according to the characteristics of spline regression, establishing a constraint equation if the adjacent fitting curves satisfy the (n−1) order continuity at the junction therebetween;

4) according to business needs, establishing boundary condition constraints at two left and right endpoints; and

5) in simultaneous consideration of steps 2) to 4), based on the minimum mean square root error, iteratively solving the coefficients of the respective polynomials in segments, thereby obtaining the photovoltaic power curve in the full irradiation segment.

Optionally, other curve fitting methods, such as a least squares method, polynomial fitting, or the like may be used to perform regression on the photovoltaic power curve, such that the obtained photovoltaic power curve converges as much as possible.

In summary, by the method for modeling the photovoltaic curve according to the embodiment of the present disclosure, the photovoltaic power curve is obtained by dividing the acquired photovoltaic data at various time points within a specified time period into at least two photovoltaic data packets, establishing packet photovoltaic power curves respectively corresponding to the at least two photovoltaic data packets according to the respective photovoltaic data of the at least two photovoltaic data packets and fitting the respective packet photovoltaic power curves of at least two photovoltaic data packets, such that the photovoltaic data is fitted in different time periods during the photovoltaic curve modeling process, thereby reducing the influence of the difference between photoelectric conversion efficiencies in different time periods on photovoltaic curve modeling, and improving the accuracy of photovoltaic curve modeling.

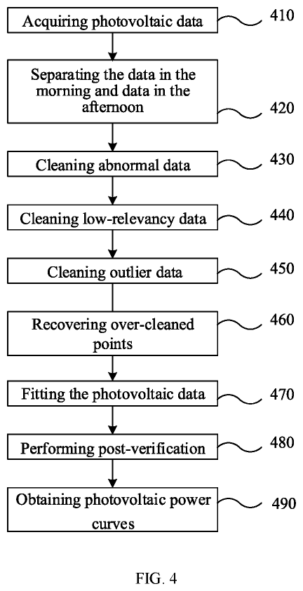

FIG. 4 shows a flowchart of a method for modeling a photovoltaic curve according to an exemplary embodiment of the present disclosure. The method for modeling the photovoltaic curve is performed by a computer device. Taking the case where the acquired photovoltaic data is divided into photovoltaic data packets in the morning and in the afternoon as an example, as shown in FIG. 4, the method includes the following steps.

1) Photovoltaic data is acquired, referring to FIG. 5. FIG. 5 shows a scatter diagram of photovoltaic data at various time points within a specified time period in a method for modeling a photovoltaic curve according to an embodiment of the present disclosure. As shown in FIG. 5, the acquired photovoltaic data include photovoltaic data at various time points within a specified time period.

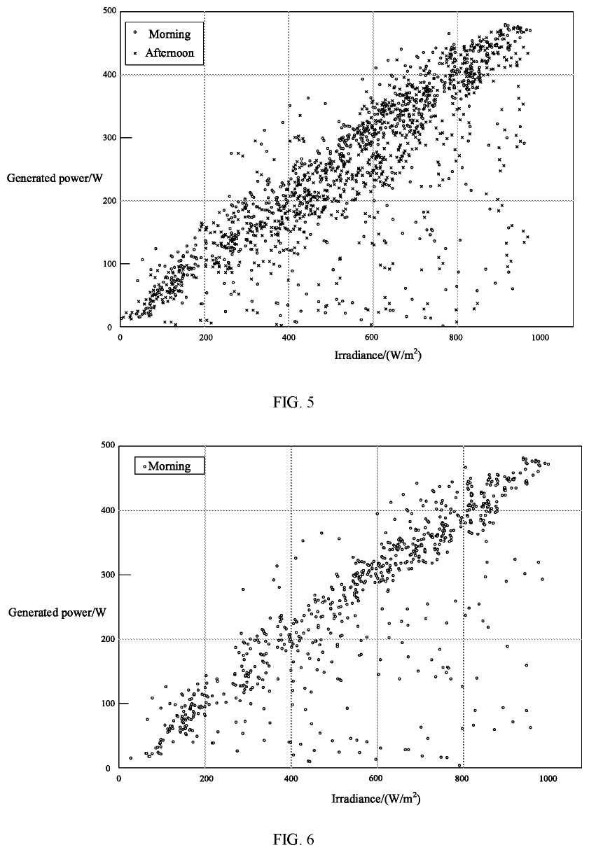

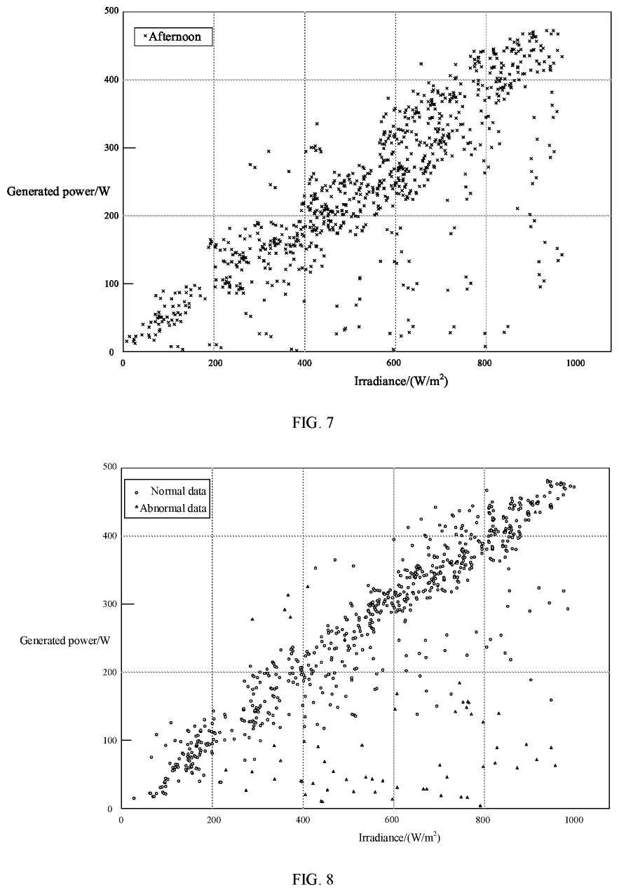

2) Data in the morning and data in the afternoon are separated, with reference to FIG. 6 and FIG. 7. FIG. 6 shows a scatter diagram of photovoltaic data in the morning in a method for modeling a photovoltaic curve according to an embodiment of the present disclosure. FIG. 7 shows a scatter diagram of photovoltaic data in the afternoon in a method for modeling a photovoltaic curve according to an embodiment of the present disclosure. As shown in FIG. 6 and FIG. 7, the photovoltaic data at various time points within the specified time period shown in FIG. 5 is divided into two photovoltaic data packets in the morning and in the afternoon based on different collection times of the photovoltaic data.

Take the processing of the photovoltaic data in the photovoltaic data packet in the morning as an example:

3) abnormal data is cleaned, with reference to FIG. 8. FIG. 8 shows a scatter diagram of abnormal data in a method for modeling a photovoltaic curve according to an embodiment of the present disclosure. As shown in FIG. 8, the abnormal data includes missing data, nighttime invalid data, overrun data, and dead numbers.

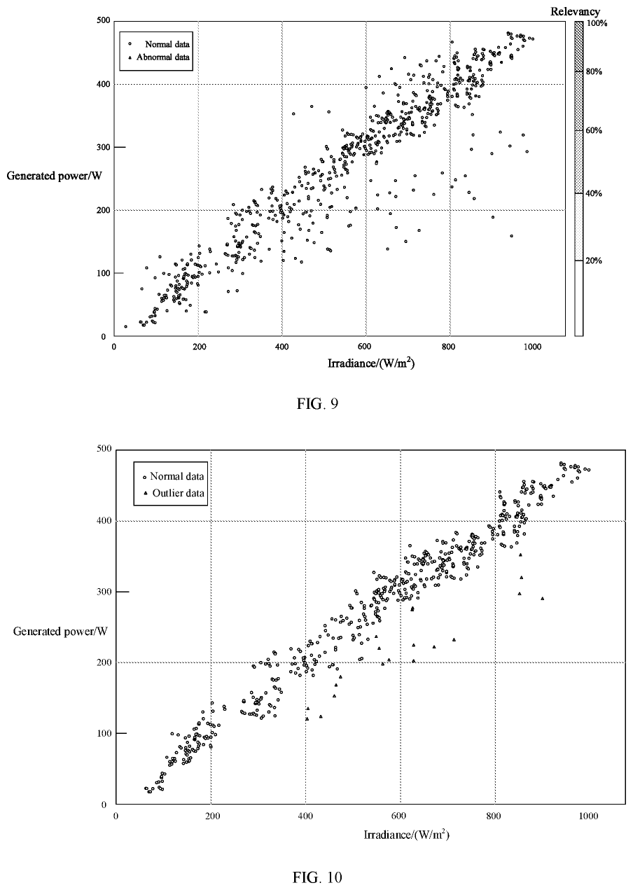

4) Low-relevancy data is cleaned, with reference to FIG. 9. FIG. 9 shows a scatter diagram of low-relevancy data in a method for modeling a photovoltaic curve according to an embodiment of the present disclosure. As shown in FIG. 9, the low-relevancy data is cleaned based on irradiance data. The low-relevancy data refers to photovoltaic data below a correlation threshold. The correlation threshold may be adjusted by changing related parameters of the computer device.

5) Outlier data is cleaned, with reference to FIG. 10. FIG. 10 shows a scatter diagram of outlier data in a method for modeling a photovoltaic curve according to an embodiment of the present disclosure. As shown in FIG. 10, the photovoltaic data away from a data concentration area in the photovoltaic data from which the low-relevancy data is removed is calculated based on the LOF algorithm, and is then cleaned.

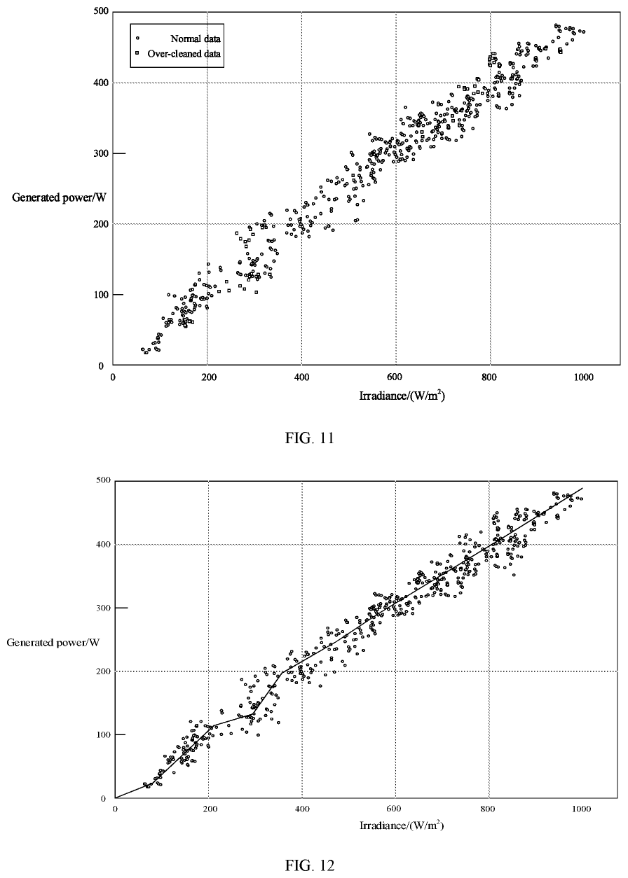

6) Over-cleaned points are recovered, with reference to FIG. 11. FIG. 11 is a scatter diagram of over-cleaned data in a method for modeling a photovoltaic curve according to an embodiment of the present disclosure. As shown in FIG. 11, the photovoltaic data in a preset area around the data concentration area is calculated based on an IQR algorithm, and the data in the preset area, which is cleaned from the above part is recovered to ensure the integrity of a photovoltaic data fitting base.

7) The photovoltaic data is fitted, with reference to FIG. 12. FIG. 12 shows a photovoltaic power curve fitting diagram in a method for modeling a photovoltaic curve according to an embodiment of the present disclosure. As shown in FIG. 12, valid photovoltaic data points reserved after cleaning is subjected to spline interpolation fitting, or the reserved photovoltaic data points are fitted by other fitting methods such as a least squares method to obtain a photovoltaic power curve.

8) Post-verification is performed to verify whether the obtained photovoltaic power curve is monotonous or satisfies the photoelectric conversion efficiency:

If the obtained photovoltaic power curve of the photovoltaic device is monotonous and satisfies a reasonable photoelectric conversion efficiency, the verified photovoltaic power curve is the photovoltaic power curve of the photovoltaic device, that is, the photovoltaic power curve obtained by fitting the photovoltaic data is the photovoltaic power curve of the photovoltaic device.

If the obtained photovoltaic power curve of the photovoltaic device is monotonous and/or does not satisfy the photoelectric conversion efficiency, the verified photovoltaic power curve is a theoretical photovoltaic power curve, and the theoretical photovoltaic power curve is acquired as the photovoltaic power curve of the photovoltaic power generation device.

9) Photovoltaic power curves are obtained. The photovoltaic data in the photovoltaic data packet in the morning is processed to obtain a photovoltaic power curve in the morning, and the photovoltaic data in the photovoltaic data packet in the afternoon is processed to obtain a photovoltaic power curve in the afternoon.

It should be noted that the steps of cleaning the abnormal data and cleaning the low-relevancy data may be performed before dividing the photovoltaic data into the at least two photovoltaic data packets, or performed after dividing the photovoltaic data into the at least two photovoltaic data packets.

In the embodiment of the present disclosure, the method for modeling the photovoltaic curve may be used to obtain photovoltaic power curves of at least two photovoltaic power generation devices. The photovoltaic power curves of the at least two photovoltaic power generation devices correspond to at least two photovoltaic data packets.

In summary, by the method for modeling the photovoltaic curve according to the embodiment of the present disclosure, the photovoltaic power curve is obtained by dividing the acquired photovoltaic data at various time points within a specified time period into at least two photovoltaic data packets, establishing packet photovoltaic power curves respectively corresponding to the at least two photovoltaic data packets according to the respective photovoltaic data of the at least two photovoltaic data packets and fitting the respective grouped photovoltaic power curves of at least two photovoltaic data packets, such that the photovoltaic data is fitted in different time periods during the photovoltaic curve modeling process, thereby reducing the influence of the difference between photoelectric conversion efficiencies in different time periods on photovoltaic curve modeling, and improving the accuracy of photovoltaic curve modeling.

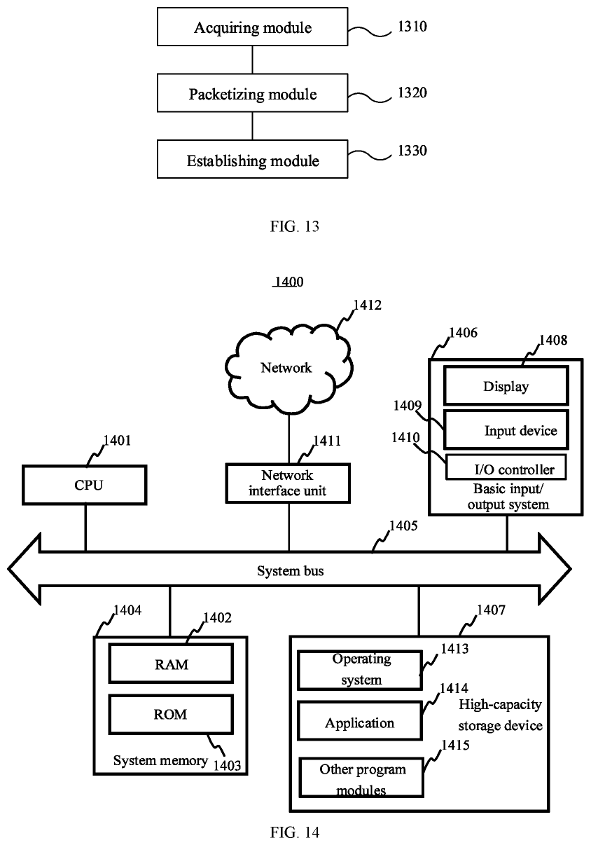

FIG. 13 shows a block diagram of an apparatus for modeling a photovoltaic curve according to an exemplary embodiment of the present disclosure. The apparatus may be practiced in a software form as all or part of a computer device to perform all or part of the steps of the method illustrated in the corresponding embodiment of FIG. 1, 2 or 4. As shown in FIG. 13, the apparatus may include:

an acquiring module 1310, configured to acquire photovoltaic data at various time points within a specified time period, wherein the photovoltaic data includes a generated power of a photovoltaic power generation device at a corresponding time point, and an irradiance collected by a radiation detection device at a corresponding time point; and the irradiation detection device is disposed at the photovoltaic power generation device;

a packeting module 1320, configured to divide the photovoltaic data at various time points into at least two photovoltaic data packets, wherein a time point corresponding to the photovoltaic data in each of the at least two photovoltaic data packets belongs to a time period in a natural day, and different packets in the at least two photovoltaic data packets correspond to different time periods; and

an establishing module 1330, configured to establish, according to the respective photovoltaic data of the at least two photovoltaic data packets, packet photovoltaic power curves respectively corresponding to the at least two photovoltaic data packets, wherein the packet photovoltaic power curve is intended to indicate a function relationship between the irradiance and the generated power.

Optionally, the apparatus further includes: a cleaning module, configured to perform data cleaning on the respective photovoltaic data of the at least two photovoltaic data packets to remove invalid photovoltaic data in the at least two photovoltaic data packets.

The establishing module 1330 is configured to establish, according to photovoltaic data of the at least two photovoltaic data packets subjected to the data cleaning, packet photovoltaic power curves respectively corresponding to the at least two photovoltaic data packets.

Optionally, the photovoltaic data includes a generated power of a photovoltaic power generation device at a corresponding time point, and an irradiance collected by a radiation detection device at a corresponding time point. The irradiation detection device is disposed at the photovoltaic power generation device. The cleaning module includes:

a first cleaning submodule, configured to clean abnormal data in the at least two photovoltaic data packets to obtain the at least two photovoltaic data packets subjected to abnormal data cleaning, wherein the abnormal data refers to data generated in the case of failure of the irradiation detection device;

a second cleaning submodule, configured to remove low-relevancy data from the at least two photovoltaic data packets subjected to the abnormal data cleaning, to obtain the at least two photovoltaic data packets subjected to low-relevancy data cleaning, wherein the low-relevancy data refers to photovoltaic data whose relevancy is lower than a relevancy threshold, and the relevancy is used to indicate a correlation between the generated power and the irradiance in the corresponding photovoltaic data;

a third cleaning submodule, configured to remove outlier data respectively based on an LOF algorithm from the at least two photovoltaic data packets subjected to the low-relevancy data cleaning, to acquire the at least two photovoltaic data packets from which the outlier data is removed, wherein the outlier data refers to photovoltaic data away from a data concentration area; and

a first acquisition submodule, configured to acquire, according to the at least two photovoltaic data packets from which the outlier data is removed, the at least two photovoltaic data packets subjected to the data cleaning.

Optionally, the first cleaning submodule is configured to:

clean missing data in the at least two photovoltaic data packets, wherein the missing data refers to data in which the irradiance data or the generated power data in the photovoltaic power data is missed;

clean nighttime invalid data in the at least two photovoltaic data packets, wherein the nighttime invalid data refers to all data obtained by the photovoltaic power detection device during the nighttime detection;

clean overrun data in the at least two photovoltaic data packets, wherein the overrun data refers to data that exceeds a reasonable irradiance data range and/or a reasonable power data range; and

clean dead numbers in the at least two photovoltaic data packets, wherein the dead numbers refer to data that appears 4 times or more in a time sequence.

Optionally, the second cleaning submodule is configured to:

establish sliding windows, wherein each of the sliding windows is established by the photovoltaic data in the at least two photovoltaic data packets subjected to the abnormal data cleaning in a time sequence by taking a time resolution of the photovoltaic data in the at least two photovoltaic data packets subjected to the abnormal data cleaning as a step length, and each n pieces of photovoltaic data as a set; the each n pieces of photovoltaic data is considered as a set of data, and one sliding window contains the set of data; and the time resolution refers to a minimum time interval at which the irradiation detection device collects two pieces of adjacent photovoltaic data at a corresponding time point;

calculate a Pearson correlation coefficient of the photovoltaic data in each of the sliding windows;

calculate a correlation value of the photovoltaic data in the at least two photovoltaic data packets subjected to the abnormal data cleaning, wherein the correlation value refers to an average value which is solved, by sorting the Pearson correlation coefficients of a plurality of sliding windows in which the photovoltaic data in the at least two photovoltaic data packets subjected to the abnormal data cleaning is located in a descending order, for the values of the middle n−2 Pearson correlation coefficients;

determine a correlation threshold, wherein the correlation threshold refers to a correlation threshold corresponding to each of data segments divided based on irradiance data segments; and

clean the photovoltaic data in the at least two photovoltaic data packets subjected to the abnormal data cleaning according to the correlation threshold.

Optionally, the first acquiring submodule is configured to:

determine over-cleaned data from respective low-relevancy data of the at least two photovoltaic data packets based on an IQR algorithm, wherein the over-cleaned data is photovoltaic data in a data concentration area and in a preset area around the data concentration area; and

recover the respective over-cleaned data of the at least two photovoltaic data packets into the at least two photovoltaic data packets from which the outlier data is removed, to obtain the at least two photovoltaic data packets subjected to the data cleaning.

Optionally, the establishing module 1330 is configured to perform spline interpolation fitting on the respective photovoltaic data of the at least two photovoltaic data packets to obtain a photovoltaic power curve of the photovoltaic power generation device.

In summary, the apparatus for modeling the photovoltaic curve according to the embodiment of the present disclosure is practiced in a software form as all or part of a computer device. The photovoltaic power curve is obtained by dividing the acquired photovoltaic data at various time points within a specified time period into at least two photovoltaic data packets, establishing packet photovoltaic power curves respectively corresponding to the at least two photovoltaic data packets according to the respective photovoltaic data of the at least two photovoltaic data packets and fitting the respective packet photovoltaic power curves of at least two photovoltaic data packets, such that the photovoltaic data is fitted in different time periods during the photovoltaic curve modeling process, thereby reducing the influence of the difference between photoelectric conversion efficiencies in different time periods on photovoltaic curve modeling, and improving the accuracy of photovoltaic curve modeling.

FIG. 14 is a schematic structural diagram of a computer device 1400 according to one exemplary embodiment. The computer device may be implemented as the computer device capable of modelling photovoltaic curves in the foregoing solutions of the present disclosure. The computer device 1400 includes a central processing unit (CPU) 1401, a system memory 1404 including a random-access memory (RAM) 1402 and a read-only memory (ROM) 1403, and a system bus 1405 connecting the system memory 1404 and the CPU 1401. The computer device 1400 further includes a basic input/output system (I/O system) 1406 which helps transmit information between various components within a computer, and a high-capacity storage device 1407 for storing an operating system 1413, an application 1414 and other program modules 1415.

The basic I/O system 1406 includes a display 1408 for displaying information and an input device 1409, such as a mouse and a keyboard, for a user to input the information. The display 1408 and the input device 1409 are both connected to the CPU 1401 by an I/O controller 1410 connected to the system bus 1405. The basic I/O system 1406 may also include the I/O controller 1410 for receiving and processing input from a plurality of other devices, such as a keyboard, a mouse and an electronic stylus. Similarly, the I/O controller 1410 further provides output to a display screen, a printer or other types of output devices.

The high-capacity storage device 1407 is connected to the CPU 1401 by a high-capacity storage controller (not shown) connected to the system bus 1405. The high-capacity storage device 1407 and its associated computer-readable medium provide non-volatile storage for the computer device 1400. That is, the high-capacity storage device 1407 may include a computer-readable medium (not shown), such as a hard disk or a CD-ROM drive.

Without loss of generality, the computer-readable medium may include a computer storage medium and a communication medium. The computer storage medium includes volatile and non-volatile, removable and non-removable media implemented in any method or technology for storage of information such as a computer-readable instruction, a data structure, a program module or other data. The computer storage medium includes a RAM, a ROM, an EPROM, an EEPROM, a flash memory or other solid-state storage technologies; a CD-ROM, DVD or other optical storage; and a tape cartridge, a magnetic tape, a disk storage or other magnetic storage devices. It will be known by a person skilled in the art that the computer storage medium is not limited to above. The above system memory 1404 and the high-capacity storage device 1407 may be collectively referred to as the memory.

According to various embodiments of the present disclosure, the computer device may also be connected to a remote computer on a network through the network, such as the Internet, for operation. That is, the computer device 1400 may be connected to the network 1412 through a network interface unit 1411 connected to the system bus 1405, or may be connected to other types of networks or remote computer systems (not shown) with the network interface unit 1411.

The memory further includes one or more programs stored in the memory. The CPU 1401 implements all or part of the steps of the method shown in FIG. 1, FIG. 2 or FIG. 4 by executing the one or more programs.

Those skilled in the art will appreciate that in one or more examples described above, the functions described in the embodiments of the present disclosure can be implemented in hardware, software, firmware, or any combination thereof. When implemented in software, the functions may be stored in a computer-readable medium or transmitted as one or more instructions or codes on the computer-readable medium. The computer-readable medium includes both a computer storage medium and a communication medium including any medium that facilitates transfer of a computer program from one location to another. The storage medium may be any available medium that can be accessed by a general-purpose or special-purpose computer.

In one exemplary embodiment, there is also provided a non-transitory computer-readable storage medium for storing computer software instructions to be used by the above terminal. The instructions include a program designed for executing the above photovoltaic curve modelling method. For example, the non-transitory computer-readable storage medium may be a ROM, a RAM, a CD-ROM, a magnetic tape, a floppy disk, an optical data storage device, or the like.

Other embodiments of the present disclosure will be apparent to those skilled in the art from consideration of the specification and practice of the present disclosure. This disclosure is intended to cover any variations, uses, or adaptations of the present disclosure following the general principles thereof and including common knowledge or commonly used technical measures which are not disclosed herein. The specification and embodiments are to be considered as exemplary only, with a true scope and spirit of the present disclosure is indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure is only limited by the appended claims.

1. A method for modeling a photovoltaic curve, comprising:
acquiring photovoltaic data at various time points within a specified time period, the photovoltaic data includes a generated power of a photovoltaic power generation device at a corresponding time point, and an irradiance collected by a radiation detection device at the corresponding time point; the irradiation detection device being disposed at the photovoltaic power generation device;
dividing the photovoltaic data at the various time points into at least two photovoltaic data packets, different packets in the at least two photovoltaic data packets corresponding to different time periods; and
establishing, according to the respective photovoltaic data of the at least two photovoltaic data packets, packet photovoltaic power curves respectively corresponding to the at least two photovoltaic data packets, wherein each photovoltaic power curve represents a relationship between the generated power and the irradiance.

2. The method according to claim 1, wherein prior to establishing, according to the respective photovoltaic data of the at least two photovoltaic data packets, the packet photovoltaic power curves respectively corresponding to the at least two photovoltaic data packets, the method further comprises:
performing data cleaning on the respective photovoltaic data of the at least two photovoltaic data packets to remove invalid photovoltaic data in the at least two photovoltaic data packets;
wherein establishing, according to the respective photovoltaic data of the at least two photovoltaic data packets, the packet photovoltaic power curves respectively corresponding to the at least two photovoltaic data packets comprises:
establishing, according to photovoltaic data of the at least two photovoltaic data packets subjected to the data cleaning, the packet photovoltaic power curves respectively corresponding to the at least two photovoltaic data packets.

3. The method according to claim 2, wherein performing the data cleaning on the respective photovoltaic data of the at least two photovoltaic data packets comprises:
cleaning abnormal data in the at least two photovoltaic data packets to obtain the at least two photovoltaic data packets subjected to abnormal data cleaning, wherein the abnormal data refers to data generated in the case of failure of the irradiation detection device;
removing low-relevancy data from the at least two photovoltaic data packets subjected to the abnormal data cleaning, to obtain the at least two photovoltaic data packets subjected to low-relevancy data cleaning, wherein the low-relevancy data refers to photovoltaic data whose relevancy is lower than a relevancy threshold, and the relevancy is intended to indicate a correlation between the generated power and the irradiance in the corresponding photovoltaic data;
removing outlier data respectively based on a local outlier factor algorithm from the at least two photovoltaic data packets subjected to the low-relevancy data cleaning, to acquire the at least two photovoltaic data packets from which the outlier data is removed, wherein the outlier data refers to photovoltaic data away from a data concentration area; and
acquiring, according to the at least two photovoltaic data packets from which the outlier data is removed, the at least two photovoltaic data packets subjected to the data cleaning.

4. The method according to claim 3, wherein cleaning the abnormal data in the at least two photovoltaic data packets to obtain the at least two photovoltaic data packets subjected to the abnormal data cleaning comprises:
cleaning missing data in the at least two photovoltaic data packets, wherein the missing data refers to data in which the irradiance data or the generated power data in the photovoltaic power data is missed;
cleaning nighttime invalid data in the at least two photovoltaic data packets, wherein the nighttime invalid data refers to all data obtained by the photovoltaic power detection device during times when the sun is absent;
cleaning overrun data in the at least two photovoltaic data packets, wherein the overrun data refers to data that exceeds a reasonable irradiance data range and/or a reasonable power data range; and
cleaning dead numbers in the at least two photovoltaic data packets, wherein the dead numbers refer to data that appears four times or more in a time sequence.

5. The method according to claim 3, wherein removing the low-relevancy data from the at least two photovoltaic data packets subjected to the abnormal data cleaning, to obtain the at least two photovoltaic data packets subjected to the low-relevancy data cleaning, comprises:
establishing sliding windows, wherein each of the sliding window is established by the photovoltaic data in the at least two photovoltaic data packets subjected to the abnormal data cleaning in a time sequence by taking a time resolution of the photovoltaic data in the at least two photovoltaic data packets subjected to the abnormal data cleaning as a step length, and each n pieces of photovoltaic data as a set, wherein the each n pieces of photovoltaic data is considered as a set of data, and one of the sliding windows contains the set of data; and the time resolution refers to a minimum time interval at which the irradiation detection device collects two pieces of adjacent photovoltaic data at a corresponding time point;
calculating a Pearson correlation coefficient of the photovoltaic data within each of the sliding windows;
calculating a correlation value of the photovoltaic data in the at least two photovoltaic data packets subjected to the abnormal data cleaning, wherein the correlation value refers to an average value which is solved, by sorting the Pearson correlation coefficients of a plurality of sliding windows in which the photovoltaic data in the at least two photovoltaic data packets subjected to the abnormal data cleaning is located in an descending order, for values of the middle n−2 Pearson correlation coefficients;
determining a correlation threshold, wherein the correlation threshold refers to a correlation threshold corresponding to each data segment of a plurality of data segments obtained by dividing each of the at least two photovoltaic data packets according to the irradiance; and
cleaning, according to the correlation threshold, the photovoltaic data in the at least two photovoltaic data packets subjected to the abnormal data cleaning.

6. The method according to claim 3, wherein acquiring, according to the at least two photovoltaic data packets from which the outlier data is removed, the at least two photovoltaic data packets subjected to the data cleaning comprises:
determining over-cleaned data from respective low-relevancy data of the at least two photovoltaic data packets based on an inter-quartile range algorithm, wherein the over-cleaned data is photovoltaic data in the data concentration area and in a preset area around the data concentration area; and
recovering the respective over-cleaned data of the at least two photovoltaic data packets respectively into the at least two photovoltaic data packets from which the outlier data is removed, to obtain the at least two photovoltaic data packets subjected to the data cleaning.

7. The method according to claim 1, wherein establishing, according to the respective photovoltaic data of the at least two photovoltaic data, the packet photovoltaic power curves respectively corresponding to the at least two photovoltaic data packets packets comprises:
performing spline interpolation fitting on the respective photovoltaic data of the at least two photovoltaic data packets to obtain a photovoltaic power curve of the photovoltaic power generation device.

8. An apparatus for modeling a photovoltaic curve, comprising:
an acquiring module, configured to acquire photovoltaic data at various time points within a specified time period, the photovoltaic data includes a generated power of a photovoltaic power generation device at a corresponding time point, and an irradiance collected by a radiation detection device at the corresponding time point; the irradiation detection device being disposed at the photovoltaic power generation device;
a packetizing module, configured to divide the photovoltaic data at various time points into at least two photovoltaic data packets, different packets in the at least two photovoltaic data packets corresponding to different time periods; and
an establishing module, configured to establish, according to the respective photovoltaic data of the at least two photovoltaic data packets, packet photovoltaic power curves respectively corresponding to the at least two photovoltaic data packets, wherein each photovoltaic power curve represents a relationship between the generated power and the irradiance.

9. A computer device, comprising a processor and a memory; wherein the memory is configured to store at least one instruction, at least one program, a code set, or an instruction set therein, which, when loaded and executed by the processor, enables the processor to perform the method for modeling the photovoltaic curve as defined claim 1.

10. A computer readable storage medium, wherein the storage medium is configured to store at least one instruction, at least one program, a code set, or an instruction set, which, when loaded and executed by a processor, enables the processor to perform the method for modeling the photovoltaic curve as defined in claim 1.
